(19) United States
(12) Patent Application Publication
(10) Pub. No.: US 2013/0211991 A1
(43) Pub. Date: Aug. 15, 2013

(54) Real-Time Trading Platform

(71) Applicant: Jayesh Kanubhai Patel, Livermore, CA (US)

(72) Inventor: Jayesh Kanubhai Patel, Livermore, CA (US)

(21) Appl. No.: 13/547,008

(22) Filed: Jul. 11, 2012

Related U.S. Application Data
(60) Provisional application No. 61/572,146, filed on Jul. 11, 2011.

(51) Int. Cl. G06Q 40/04

(52) U.S. Cl. CPC G06Q 40/04
USPC 705/37

(57) ABSTRACT

An asset trading platform system and method is described for real-time trading of assets. The system acts as an intermediary among members, broker dealers, and exchanges, and matches orders to bids to complete transactions in real time between buyers and sellers on open markets. The trading platform provides 1-click trading for instantaneous, secure connectivity to markets and interaction with live real-time market feed data for the generation and completion of trades over wired or wireless networks. Users PCs, laptops, or wireless devices can be configured to receive a stream of market data as a streaming quote or scrolling ticker that can be acted upon in real time by multiple users across multiple financial institutions or brokers instantaneously and securely. Users can send trade details to brokerage firms, banks, or directly to exchanges with end-to-end, secure connectivity, and real-time trading capability through wired or wireless electronic exchange networks.

### CROSS-REFERENCE TO RELATED APPLICATIONS

This application claims priority to U.S. Provisional Application No. 61/572,146, filed Jul. 11, 2011, which is incorporated herein by reference in its entirety.

### FIELD OF THE INVENTION

The present invention relates generally to assets trading and in particular to a real-time platform for executing assets trading transactions.

### BACKGROUND

The first electronic trading platforms were associated with stock exchanges and allowed brokers to place orders remotely using private dedicated networks and dumb terminals. Early systems would not always provide live streaming prices and instead only allowed brokers or clients to place orders which would be confirmed at some later time. These were known as “request for quote” systems. Trading systems evolved to allow for live streaming prices and near instant execution of orders as well as using the Internet as the underlying network meaning that location became much less of an issue. Some modern electronic trading platforms provide a graphical user interface to allow users to trade currencies, equities, options, futures, commodities, bonds, and treasuries, and also to develop automatic or algorithmic trading systems, which have been used by high frequency traders.

Generally, electronic trading platforms are computer systems that can be used to place orders for financial products over a network using a financial intermediary such as brokers, market makers, investment banks or stock exchanges. Such platforms allow electronic trading to be carried out by users from any location and are in contrast to traditional floor trading using open outcry and telephone-based trading. But such systems have heretofore required intermediaries to actually perform the trades which make real-time trading relatively impossible for the average person.

Due to cumbersome connectivity for users to connect with financial markets for viewing market data and trading, heretofore it has been difficult or impossible to instantaneously connect with domestic and international financial markets in real time for the average user. In addition, trading capabilities on remote devices, such as wireless handheld devices, are limited and currently do not provide wireless real-time trading, nor do they allow users to view trading details of assets in real time such as stocks, commodities, bonds, options, derivatives, or upcoming new innovative trading products.

E-Trade and Scottrade, among others, were influential in establishing online trading that shook up the old brokerage industry model. Now it is commonplace, and wireless trading is going to be the next revolution. It will however be very difficult and expensive for most brokerage houses to implement and maintain all the wired and wireless technology available today and in the future. In order for brokerage firms to be able to offer use all the wireless models and networks, a packaged product needs to be provided. Brokerage firms do not have the time and resources to invest in and learn this technology while simultaneously maintaining their own private network products.

### SUMMARY

An asset trading platform system and method is described for real-time trading of assets. The system can provide trading based on accurate and precise information as well as assurance of execution and immediate confirmation. The system acts as an intermediary among members, broker dealers, and exchanges, and matches orders to bids to complete transactions in real time between buyers and sellers on open markets. The trading platform provides 1-click trading for instantaneous, secure connectivity to markets and interaction with live real-time market feed data for the generation and completion of trades over wired or wireless networks.

Users PCs, laptops, or wireless devices, etc. can be configured to receive a stream of market data as a streaming quote or scrolling ticker that can be acted upon in real time by multiple users across multiple financial institutions or brokers instantaneously and securely. The trading platform can provide instantaneous connectivity at the time when users are ready to view asset details of assets such as stocks, commodities, bonds, options, derivatives, as well as any new innovative trading products. Users can send trade details to brokerage firms, banks, or directly to exchanges with end-to-end, secure connectivity, and real-time trading capability to exchanges, brokerage firms, or banks through wired or wireless networks.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, in which:

FIG. 1A depicts an example embodiment of an automated trading system.

FIG. 1B depicts an example embodiment of an automated trading system.

FIG. 2 depicts an example embodiment of a process for account registration.

FIG. 3 depicts an example embodiment of a process for receiving real-time market feed data.

FIG. 4 depicts an example embodiment of a process for executing a market order transaction.

FIG. 5 depicts an example embodiment of a process for executing a limit order transaction.

FIG. 6 depicts an example embodiment of a process for a real-time trading transaction.

FIG. 7 depicts an example embodiment of a process for initiating a trading transaction.

### DETAILED DESCRIPTION

Throughout this description, for the purposes of explanation, numerous specific details are set forth in order to provide a thorough understanding of the invention. It will be apparent, however, to persons skilled in the art that the embodiments described herein may be practiced without some of these specific details. In other instances, well-known structures and devices are shown in block diagram form to avoid obscuring the underlying principles of the various embodiments.

Presently, the various global trading markets are not connected in any significant way. As a result, trade execution is often delayed and there is no guarantee of securing the best execution. Embodiments described herein solve this problem by providing a cloud-based software-as-a-service (SAAS) that enables traders to simultaneously route their orders to multiple global market exchanges to ensure immediate execution and the best available price. The assets trading platform technology described herein can be used by retail or professional traders to have secure real-time connectivity to electronic exchange systems and networks. The platform includes a real-time trading architecture that facilitates transactions based on accurate and precise data, assurance of execution, and immediate confirmation. Any asset class can be traded on the novel trading platform disclosed herein including equities, bonds, options, futures, commodities, government treasuries, derivatives, and even assets on foreign exchanges (Forex), as well as any new innovative trading products in the future. The platform is accessible through specialized client software that can be downloaded onto users' devices and that interacts with an exchange connect server through various well-known client-server protocols available for communication over the Internet or other networks. Users can send trade transaction details from any remote devices or systems such as desktops, laptops, smartphones, eReaders, or other browser capable devices upon which the client software can be installed.

The system acts as an intermediary among members, broker dealers, and exchanges to enable matching orders to bids in real time completing transactions between buyers and sellers on open markets. The trading platform also is configured as an overlay of proprietary systems of the exchanges, brokerage firms and banks. Once integrated, the system allows direct connection to multiple one of these institutions' proprietary networks and systems instantaneously and concurrently without the need to individually login and provide user credentials to each system. In this scenario, the system acts as an aggregator of electronic trading systems for fast, real-time trading data and transactions among multiple open markets and networks to obtain the best price instantaneously among a plurality of users. When an order is transmitted to the platform, its pertinent characteristics will be recorded including price, quantity, and the time the order was placed. The platform receives and maintains all orders received in a queue for execution.

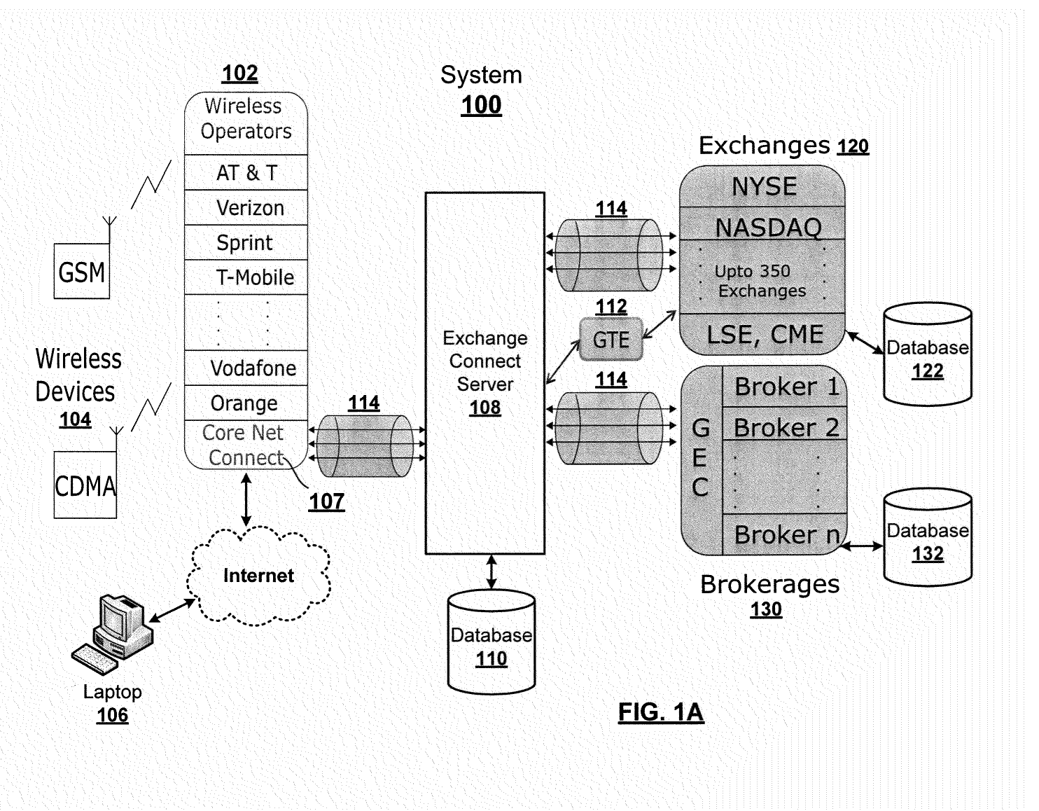

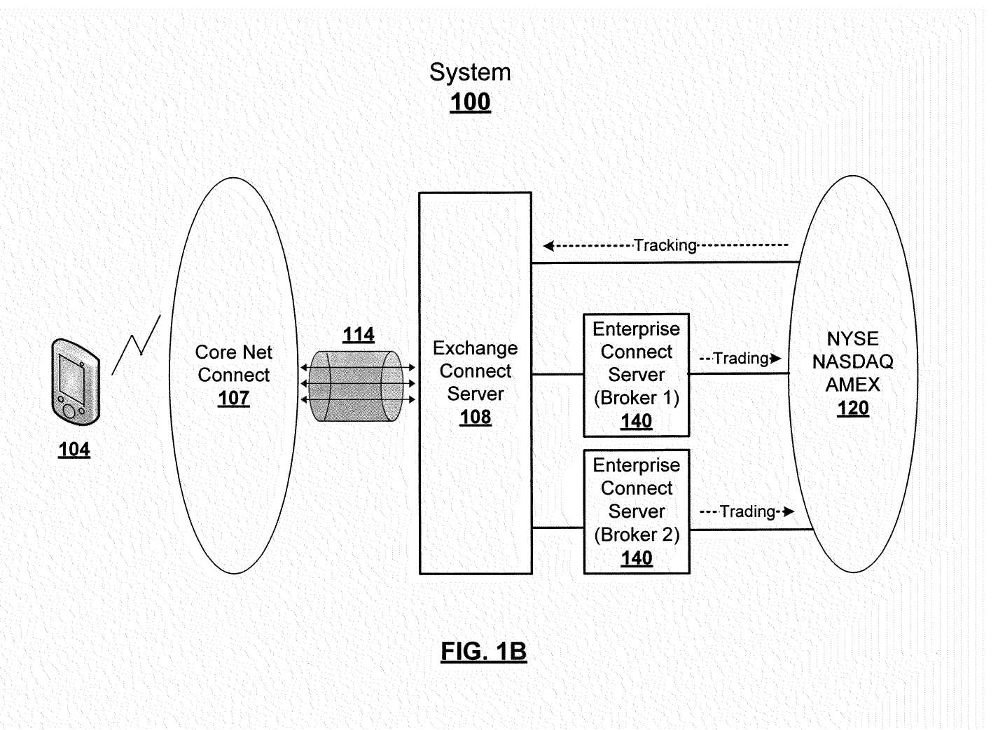

FIG. 1A depicts an example embodiment of an automated trading system. In the illustrated embodiment, wireless operators 102 connect to exchange connect server 108 through core net connect module 107 over one or more links 114. In a preferred embodiment, links 114 are point-to-point (“P2P”) or point-to-multi-point connections, but embodiments are not so limited as any wired or wireless connection can be used. Wireless operators receive network traffic from wireless user devices 104 on their respective networks. As depicted, both GSM and CDMA networks can be used as well as any other wireless communications networks or protocols. Core net connect module 107 can also be coupled with user PCs or laptop computers 106 over the Internet or other networks. Core net connect 107 is designed to facilitate trading in the financial services networks over wireless networks. Core net connect module 107 is highly scalable, fault tolerant, and utilizes redundant hardware widely available to any wireless operator around the world. In a preferred embodiment, module 107 can be an ATCA compliant chassis with dedicated P2P links 114 with exchange connect server 108.

Exchange connect server 108 runs various exchange connect software modules and has interfaces for wired or wireless connectivity to exchanges, brokerage firms, banks, and other financial institutions and networks. Exchange connect server 108 is coupled with a database 110 to store user profile and authentication information. Exchange connect server 108 has a separate client for GSM and CDMA-based wireless mobile devices. Client software can be coded in Java, C++, or any another software programming language. The client software can initialize from a user's mobile device processor and can have built-in security. The software can be downloaded from a registration server that can be part of exchange connect server 108 or a separate server coupled thereto (not shown) to connect directly to mobile devices. From a desktop or laptop users can also upload the mobile software to their mobile devices over the Internet or other network. Through the client software, wireless devices can record all transactions.

Exchange connect server 108 offers simultaneously connectivity with multiple wireless operators, exchanges, and brokerage firms, banks and other financial institutions and networks. The exchange connect server 108 offers creation of new user accounts via online and mobile devices. It has an interface with a database server (not shown) that can store users' profile information to database 110 to verify every user's profile information before providing connectivity to the system. Exchange connect server 108 includes logic that can further be configured to keep track of all users' incoming requests (for quote, streaming, or scrolling request). It can provide dedicated connectivity of many wireless operators to one or more financial institutions simultaneously and seamlessly.

In a preferred embodiment, the exchange connect server 108 includes a scroll engine (not shown) that can accept market data feeds from the various 350+ exchanges around the world, some of which can provide data in the specific financial information exchange (FIX) format and some can provide only raw data. Exchange connect server 108 also includes a trading engine (not shown) that is configured to accept order details from wireless devices or fixed-wire line connectivity. For order processing and forwarding, exchange connect server 108 can connect to enterprise connect servers as shown and described with respect to FIG. 1B.

In FIG. 1A, exchange connect server 108 is shown coupled with exchanges 120 and brokerage firms 130 via connections 114. Other connection types are possible as long as they provide real-time connectivity and security. For order execution, exchange connect server 108 connects to global trade execution engine (GTE) 112. As shown, it can connect with one or more exchanges 120 (NYSE, NASDAQ, etc.) through GTE 112. In certain embodiments, exchange connect server 108 provides connectivity to multiple exchanges simultaneously to facilitate obtaining the best price for a particular transaction. Each of exchanges 120 is coupled with a database 122 for storing transaction and user data. It can also connect to one or more brokerage firms 130 directly over links 114. Each brokerage firm is also coupled with its own database 132 for storing transaction and user data.

Embodiments are also adapted to connect to the exchanges 120 through enterprise connect servers 140 at the brokerage firms as depicted in FIG. 1B. In the illustrated embodiment, exchange connect server 108 is connected to user devices 104 using core net connect module 107 through data links 114. Exchange connect server 108 can also connect with the exchanges 120 through enterprise connect servers 140 located in the brokerage firms' networks as shown. These enterprise connect servers 140 facilitate trading on the exchange through proprietary broker networks. In one embodiment, the enterprise connect servers 140 have software for brokerage houses to connect between their proprietary networks (as well as the networks of other brokers and financial institution) and the exchange connect server 108.

GTE 112 (not shown in FIG. 1B) provides connectivity between the exchange connect server 108 and the enterprise connect servers 140. GTE 112 provides price matching for all trades, searches for the best price, and compares all available trading exchanges. GTE 112 is also configured to run the execution engine for trades. Trading messages arrive at GTE 112 from the exchange connect server 108, which will forward the trading messages to the enterprise connect servers 140. After execution of an order, GTE 112 provides confirmation messages to the exchange connect servers 108 and the enterprise connect servers 140.

Servers 140 include an interface adapter to convert wireless message headers and payload to FIX format messages. They will have an adapter for stocks, bonds, commodities, options, derivatives, as well as many other financial products. Servers 140 further will have database interface such as those provided by Oracle, MySQL, Sybase, DB2, etc. These interfaces will allow for easy connection with databases which can be configured according to each broker's requirements to store subscriber account profile data and trading transaction details. These servers can then controls incoming and outgoing traffic as well as interface with firewalls, routers and switches. In one embodiment, the enterprise connect servers will have many hardware versions from series of 2 U, 4 U up to 16 slots chassis (reliability, scalable, and full redundancy). It is an advantage for the brokerage firms since because the enterprise connect servers 140 are configured to maintain connectivity with wireless operators globally and can maintain 2500+ different wireless device functionality. Like users of the systems and trading platform disclosed herein, the brokerage firms can also connect with any of the available exchanges for best price and fast execution of the orders. Since deregulation, brokers can sell or buy with best price from any exchanges. Brokerage firms can therefore save substantial costs by not investing directly into technology, but can still increase their market share in the industry and reach any number of wireless users and devices globally in timely manner

Another of the advantages of the trading platform disclosed herein is that mobile users can create portfolios in their devices or via the desktop/laptop software and synchronize it. For each asset in a user's portfolio, a scrolling ticker will carry the symbol, price and change information for the previous day's close. Users select what information they want to be scrolled or streamed on their devices including symbol, price, change, volume, bid, ask, chart, etc. With one touch or click users will have the capability to trade from streaming data or scrolling feature. Some user devices may further have the capability to place an order though a voice reorganization feature. For security, the client software is encrypted to accept only proprietary messages from the trading platform.

The system and platform disclosed herein is also advantageous to allow users to manage more than one account simultaneously (e.g., multiple accounts with Morgan Stanley, Fidelity, Citibank, Charles Schwab, etc.) without having to login to each account separately through a web browser and enter credentials to begin trading. Once users register with all account details at time of registration, then thereafter whenever they are ready to the system will prompt which account that the user wants to trade from. Thus users can save time and easily manage multiple accounts once to access the best price and fastest execution for each transaction. Since trading is time sensitive, all traders can benefit by pushing orders faster in less time. All incoming and outgoing messages have the latest encryption and decryption methodology.

In addition, all users can determine any algorithm they want to use for smart trading. Entire stock portfolios can be executed in any increment from small to large blocks. Users can select which of the available exchanges for execution of orders.

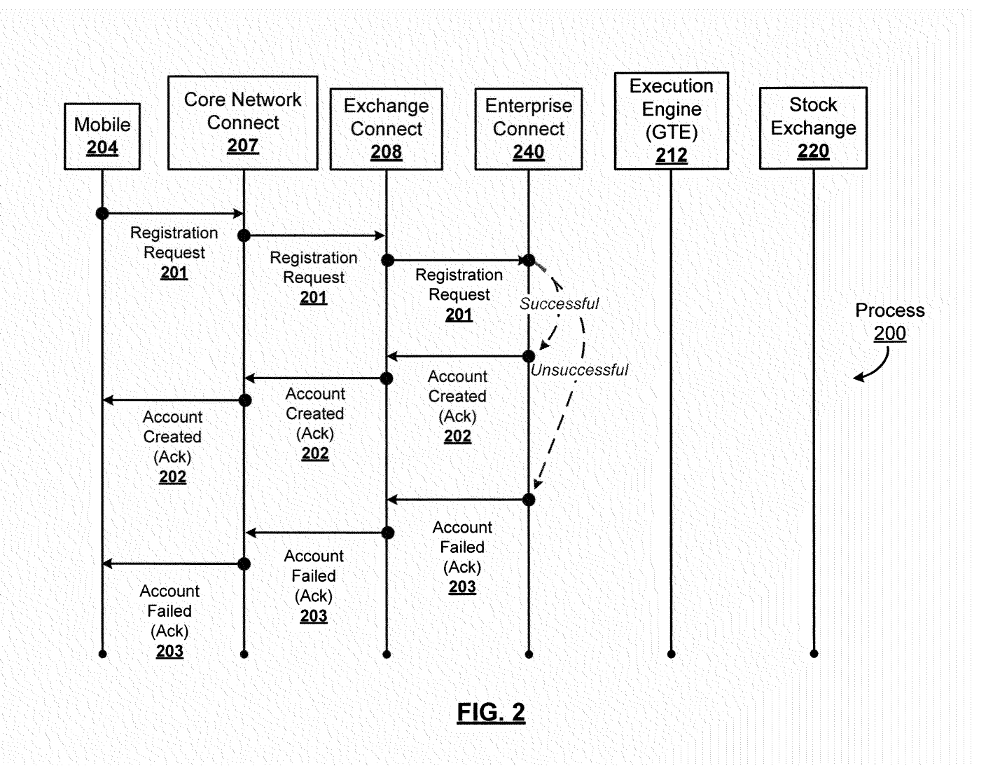

After downloading the client software on a mobile device, users can then provision the software with the registration server for completing registration process. Upon completing successfully, the user's data can be mirror copied to database 110. Users will receive a message upon successful installation of the client software on their mobile devices. FIG. 2 depicts an example embodiment of a process for account registration. In the illustrated embodiment, process 200 begins with receiving a registration request 201 from a user's mobile device 204 at the core connect module 207 and forwarding it to the exchange connect server 208 for processing. The exchange connect server 208 then passes the registration request 201 to an enterprise connect server 240 at a brokerage firm. Upon successful registration, an account created message and acknowledgement 202 is then passed back to the user. Upon successful registration, an account failed message 203 is passed back to the user. This completes process 200 according to one embodiment.

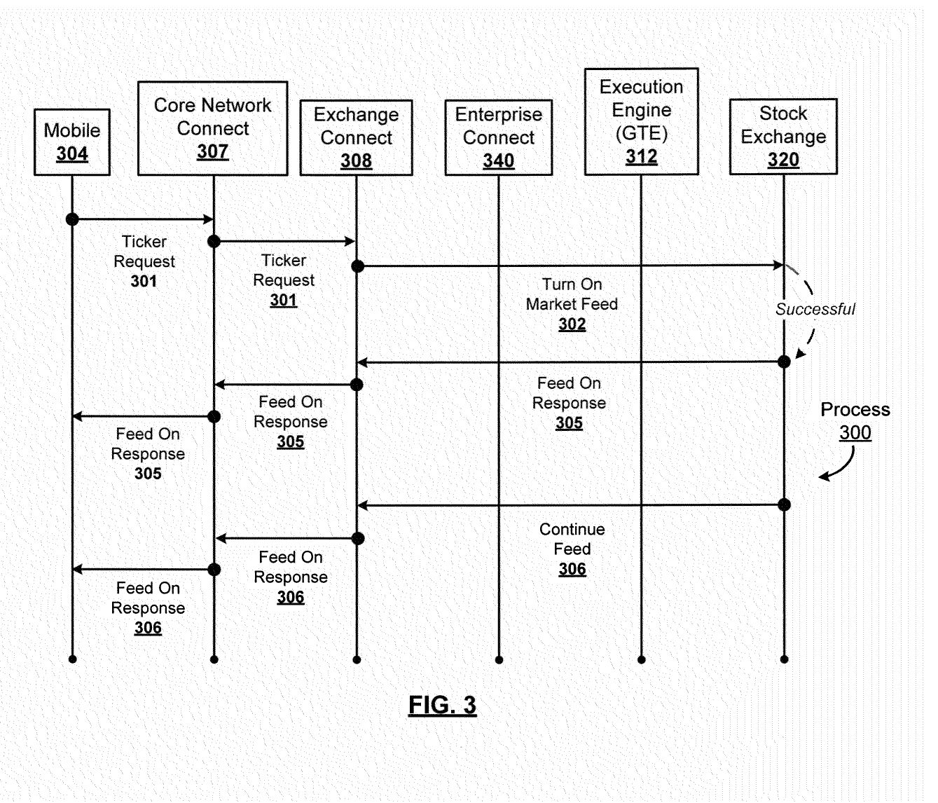

FIG. 3 depicts an example embodiment of a process for receiving real-time market feed data. In the illustrated embodiment, process 300 begins by receiving a ticker request 301 from a user's mobile device 304 at the core connect module 307 and forwarding it to the exchange connect server 308 for processing. The exchange connect server 308 then sends a turn on market feed signal 302 to one or multiple exchanges, and then in response, receives a feed on response 305 from the one or multiple exchanges. The feed on response 305 is then passed back to the user 304 via the core network connect 307. This process continues as long as a feed is being provided to the user's device from the one or more exchanges (feed on response 306). This completes process 300 according to one embodiment.

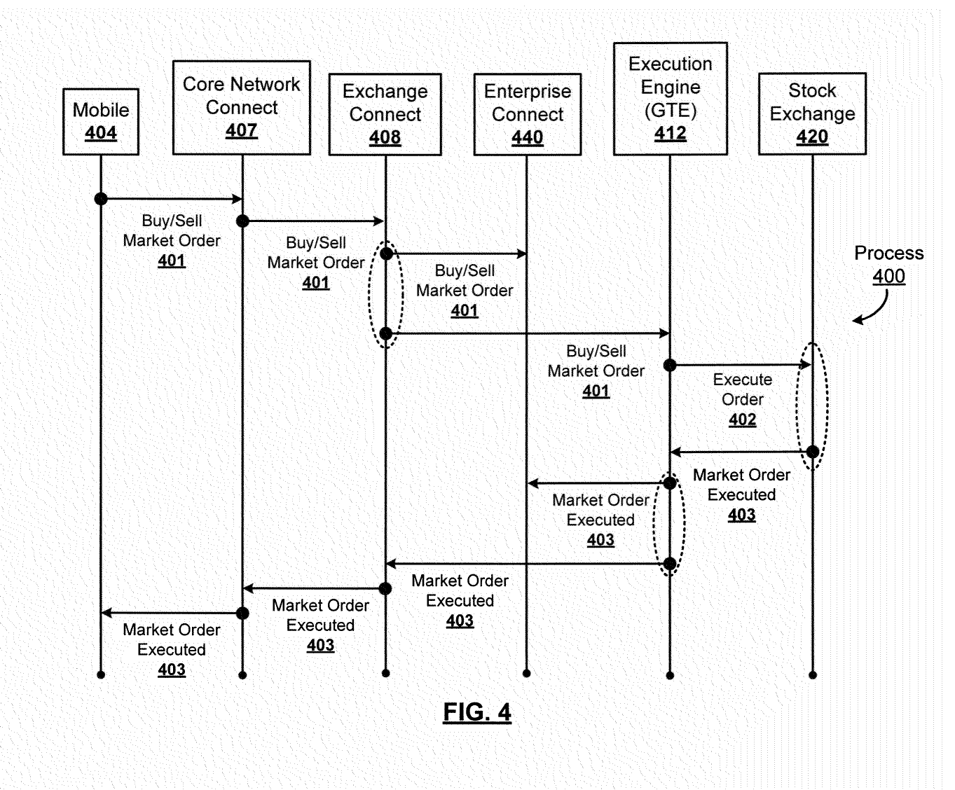

FIG. 4 depicts an example embodiment of a process for executing a market order transaction. In the illustrated embodiment, process 400 begins by receiving a buy or sell market order 401 at the core net connect module 407 from a user's device 404 and then forwarding order 401 to the exchange connect server 408. The exchange connect server 408 then simultaneously provides the buy/sell market order 401 to an enterprise connect server 440 at one or multiple brokerage firms as well as to an exchange execution engine (GTE) 412. The enterprise connect server 440 performs order and risk analysis while the GTE 412 then waits for the best price among one or multiple exchanges 420, executes the transaction, and sends an execute order message 402 to the stock exchange 420 having the best available price. The GTE 412 then receives a market order executed message 403, which is simultaneously passed on to the enterprise connect server 440 at the brokerage house as well as to the exchange connect server 408 and then ultimately back to the user device 404. This completes process 400 according to one embodiment.

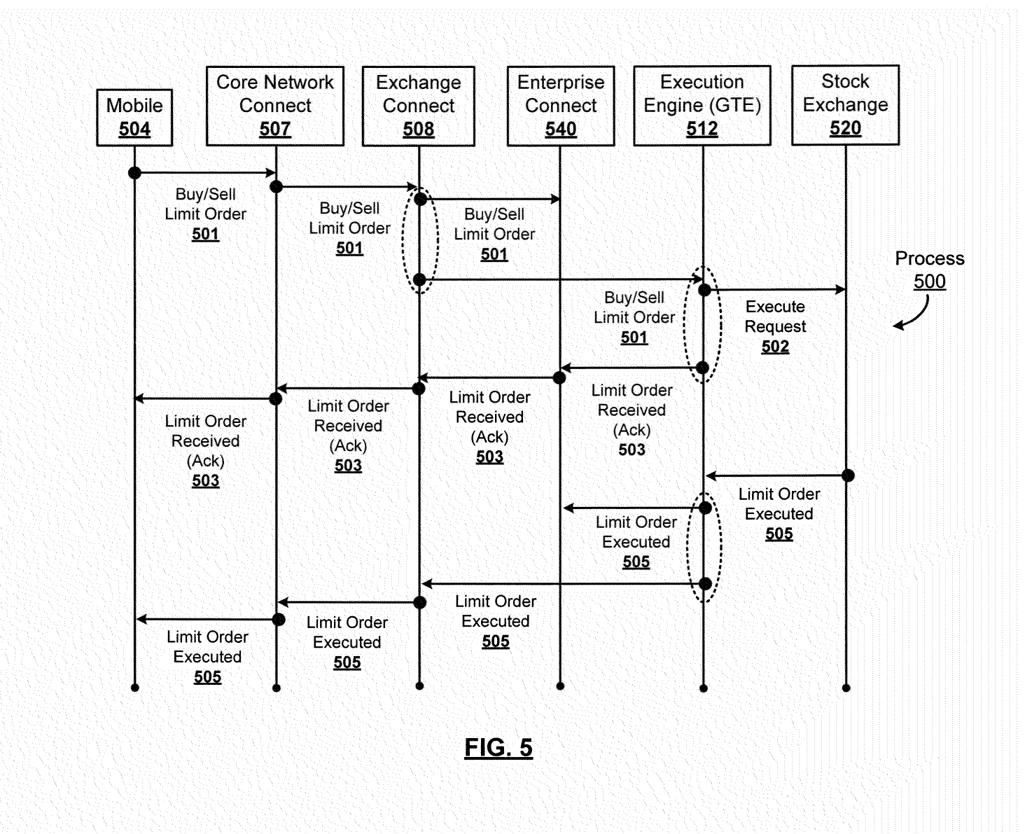

FIG. 5 depicts an example embodiment of a process for executing a limit order transaction. In the illustrated embodiment, process 500 begins by receiving a buy or sell limit order 501 at the core net connect module 507 from a user's device 504 and then forwarding the order 501 to the exchange connect server 508. The exchange connect server 508 then simultaneously sends the buy/sell limit order 501 to an enterprise connect server 540 at one or multiple brokerage firms as well as to an exchange execution engine (GTE) 512. The enterprise connect server 540 performs order and risk analysis while the GTE 512 waits for the best price among one or multiple exchanges 520 and sends an execute order request message 502 to the stock exchange 420. GTE 512 then sends a limit order received acknowledgement message 503, which gets passed back to the user. Upon confirmation that the best price has been matched for processing the limit order, the limit order is executed and a message 505 to that effect is then received by the enterprise connect server 540 and passed back to the user 504 along with the transaction details. This completes process 500 according to one embodiment.

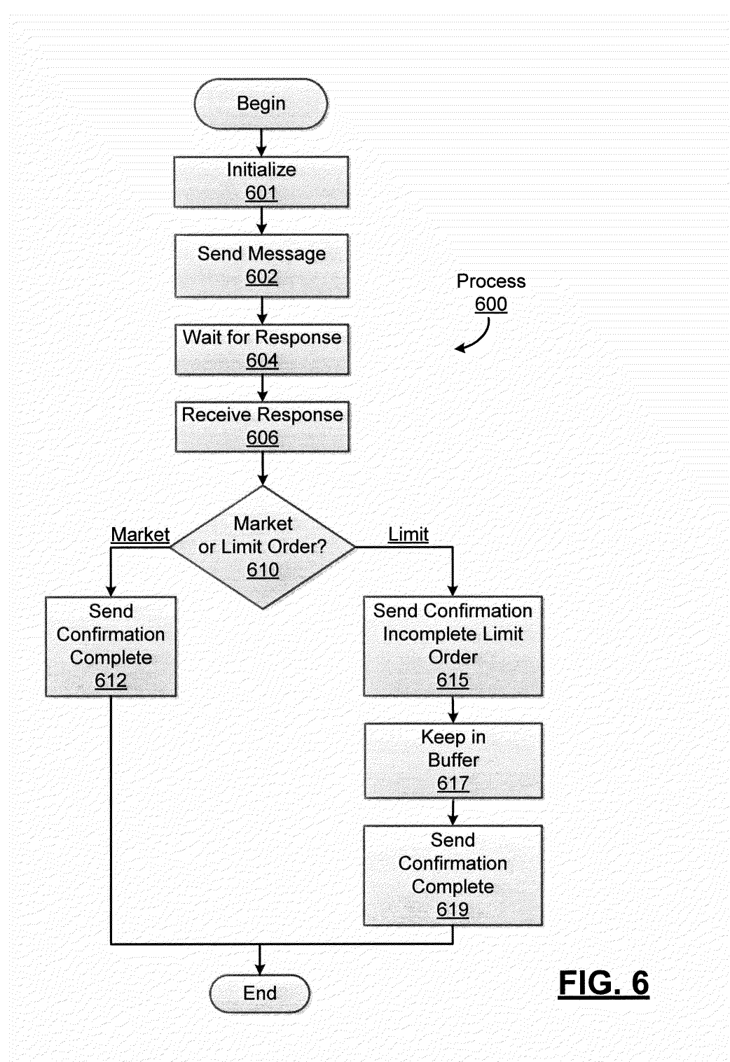

FIG. 6 depicts an example embodiment of a process for a real-time trading transaction. In the illustrated embodiment, process 600 begins at operation 601 where the system is initialized. A message is then sent (operation 602) and a response is received (operation 606). If the order was a market order in operation 610, then a confirmation complete message is sent (operation 612) and the process is completed. If the order received was a limit order, a conformation incomplete limit order message is first sent (operation 615) and the order is kept in a buffer until the limit price is matched (operation 617). Once the limit price has been matched, a confirmation complete message is sent (operation 619) and the process completes. This completes process 600 according to one embodiment. State diagram 1 below shows the different states corresponding to process 600.

State Diagram 1

| | State | Action | Next State |
|---|---|---|---|
| 1. | Idle | None | Initialize or Power off |
| 2. | Initialize | Create Session | Ready for Send Message |
| 3. | Send Message | Send Assembled Message | Wait for response |
| 4. | Wait for response | Expect messages from GEC | Goto Response Receive |
| | | (Start timer) | |
| 5a. | Response receive for | Send confirmation, (Transaction | Order Complete |
| | (Mkt order) | Complete), (End Timer) | |
| 5b. | Response receive for | Send Confirmation (order receive, | Keep in buffer |
| | (Limit order) | Incomplete transaction), | |
| | | (Start timer for 72 hrs.) | |
| 6. | Keep in buffer | Expect message from GEC (Send | Order complete, or Keep in |
| | | Status: Complete/Incomplete) | buffer |
| 7. | Order Complete | Send Confirmation | Idle |

Select stock to be traded from streamer, scrolling ticker or single quote screen. If broker login is not done then go back to login prompt. After login (successfully), trading screen, fill up all necessary fields. Send request encryption to wireless network to Broker/Exchange. User will have choice to select exchange. User request will go through wireless network and forward it to the core net connect, which will identify the message and forward it to the exchange connect server and directly to broker network. If request go to broker then it will receive by enterprise connect server and will be forwarded to the broker network and await confirmation. If it is limit order then acknowledgment and message will be received with (account name, account number, numbers of shares, price to be traded, order type, confirmation number). If it goes to proprietary network of the exchange connect server, then that server determines which broker ID is attached to the message and then forwards it to designated broker network and await a response from the broker network. If the order was executed (e.g, market orders) then a confirmation will be sent. If it is a limit order then keep a reference in the state machine buffer and send confirmation with account details to the trader. Expect message from broker network anytime (before market closes, or carry forward to next day, send order change or open order info).

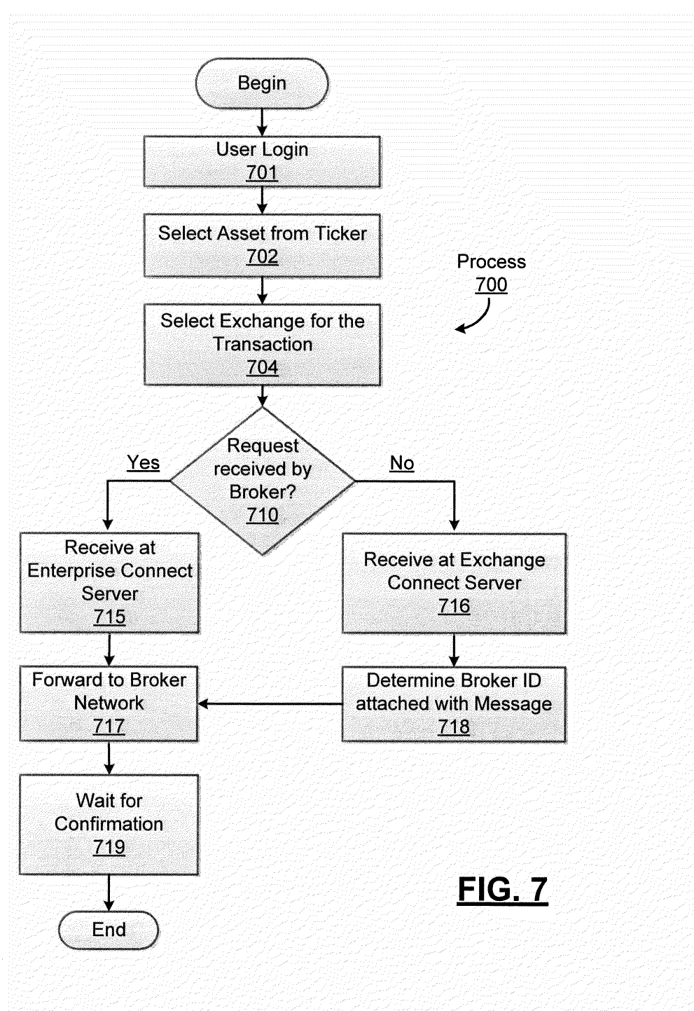

FIG. 7 depicts an example embodiment of a process for initiating a trading transaction. In the illustrated embodiment, process 700 begins at operation 701 when a user login message is received. A user then selects an asset to trade from the ticker provided on the user's device (operation 702) and also can select an exchange for the transaction (operation 704). If the request was received by a broker at operation 710, then the message is received at the enterprise connect server of the brokerage house (operation 715) and forwarded to the broker network (operation 717) where confirmation is awaited (operation 719). If the request is not received by a broker at operation 710, then the message is received at the exchange connect server (operation 716) and the broker ID associated with the message is determined at operation 718. The exchange connect server then forwards the message to the broker network matching the broker ID at operation 717 where confirmation is awaited (operation 719). This completes process 700 according to an example embodiment.

Although the present invention has been particularly described with reference to the preferred embodiments thereof, it will be readily apparent to those of ordinary skill in the art that changes and modifications in the form and details of the disclosed embodiments can be made without departing from the spirit and scope of the invention. The techniques described herein are not limited to any specific hardware circuitry or software, or combination thereof. It will be apparent to skilled artisans from this description that aspects of the invention may be embodied in software, hardware, firmware, or a combination of these. Operations may be embodied in computer-executable instructions which cause a general-purpose or special-purpose processor to perform the disclosed operations. In other embodiments, the operations can be implemented with custom hardware alone, or performed by specific hardware components that contain hardwired logic.

Further, embodiments disclosed herein may include various operations as set forth above, or fewer or more operations, or operations in an order different from the order described. The invention relates to apparatus for performing the operations herein. This apparatus may be specially constructed for the required purposes, or it may comprise a general purpose computer selectively activated or reconfigured by a computer program stored in the computer. Such a computer program may be stored or transmitted in a machine-readable medium. A machine-readable medium can be used to store software and data which when executed by a data processing system it causes the system to perform various methods. This executable software and data may be stored in various places including for example a read-only memory (ROM), a random access memory (RAM), a volatile RAM, or other non-volatile memory.

Further, a machine-readable medium may include any mechanism that stores information in a form accessible by a machine (e.g., a computer, network device, personal digital assistant, manufacturing tool, any device with a set of one or more processors, etc.). For example, a machine readable medium includes recordable or non-recordable media such as a machine-readable storage medium (e.g., any type of disk including floppy disks, optical disks, CD-ROMs, and magnetic-optical disks, ROMs, RAMs, EPROMs, EEPROMs, flash memory, magnetic or optical cards, or any type of media suitable for storing electronic instructions).

Additionally, it will be understood that the various embodiments described herein may be implemented with data processing systems which have more or fewer components than system 700. For example, such data processing systems may be a cellular telephone or a personal digital assistant (PDA) or an entertainment system or a media player (e.g., an iPod) or a consumer electronic device, etc., each of which can be used to implement one or more of the embodiments of the invention. The algorithms and displays presented herein are not inherently related to any particular computer system or other apparatus. Various general purpose systems may be used with programs in accordance with the teachings herein, or it may prove convenient to construct more specialized apparatuses to perform the method operations. The structure for a variety of these systems appears from the description above. In addition, the invention is not described with reference to any particular programming language. It will be appreciated that a variety of programming languages may be used to implement the teachings of the invention as described herein.

Accordingly, the scope of the invention should be judged in terms of the claims which follow as well as the legal equivalents thereof.

What is claimed is:

1. An asset trading server comprising:
a processor;
an interconnect bus; and
a memory coupled with the processor over the interconnect bus, the memory configured to store a secure platform for real-time trading of assets across multiple available exchanges, the platform comprising:
a scroll engine adapted to receive a market data feed from one or multiple of the available exchanges and to provide the market data in real-time to a wired or wireless user's device as a streaming or scrolling ticker;
an aggregator module configured to combine multiple user accounts into one accessible using a single set of login credentials without having to separately login to each of the multiple user accounts; and
a trading engine configured to receive and process transaction requests from a single click of the user's device.

2. The asset trading server of claim 1, wherein the aggregator module provides simultaneous connectivity with multiple wireless operators, exchanges, brokerage firms, and banks from a single platform.

3. The asset trading server of claim 1, further comprising an interface with a database server configured to store user profile and authentication information.

4. The asset trading server of claim 1, further comprising encrypting and decrypting incoming and outgoing messages.

5. The asset trading server of claim 1, further comprising an adapter that converts messages received into financial information exchange (FIX) format.

6. The asset trading server of claim 1, wherein the trading engine is configured to search for and compare the best price among the available exchanges.

7. The asset trading server of claim 1, wherein the trade engine receives messages from an exchange connect server and forwards them to an enterprise connect server at a brokerage firm.

8. The asset trading server of claim 1, wherein a scrolling ticker is provided to a user's device upon receiving a scrolling ticker request from the user.

9. The asset trading server of claim 1, wherein a transaction request is forwarded to a trade execution engine to access the best price among the available exchanges when the request is received for a buy or sell transaction from a user's device.

10. The asset trading server of claim 9, wherein the request is also forwarded to an enterprise connect server to perform order and risk analysis while the trade execution engine is accessing the best price when the request is received from the user's device.

11. An method for processing asset trading transactions on a secure platform for real-time trading of assets across multiple available exchanges comprising:
receiving a market data feed from one or multiple of the available exchanges;
providing the market data in real-time to a wired or wireless user's device as a streaming or scrolling ticker;
aggregating multiple user accounts into one accessible using a single set of login credentials without requiring the user to separately login to each of the multiple user accounts; and
receiving and processing transaction requests from a single click of the user's device.

12. The method of claim 11, further comprising providing simultaneous connectivity with multiple wireless operators, exchanges, brokerage firms, and banks from a single platform.

13. The method of claim 11, further comprising interfacing with a database server configured to store user profile and authentication information.

14. The method of claim 11, further comprising encrypting and decrypting incoming and outgoing messages.

15. The method of claim 11, further comprising converting messages received into financial information exchange (FIX) format.

16. The method of claim 1, further comprising searching for the best price among the available exchanges.

17. The method of claim 11, further comprising receiving messages from an exchange connect server and forwarding them to an enterprise connect server at a brokerage firm.

18. The method of claim 11, wherein a scrolling ticker is provided to a user's device upon receiving a scrolling ticker request.

19. The method of claim 11, further comprising forwarding a transaction request to a trade execution engine to access a best price among the available exchanges when a request is received for a buy or sell transaction from a user's device.

20. The method of claim 19, further comprising forwarding the request to an enterprise connect server to perform order and risk analysis while the trade execution engine is accessing the best price.
